(19) United States
(12) Patent Application Publication
(10) Pub. No.: US 2024/0366012 A1
(43) Pub. Date: Nov. 7, 2024

(54) VEHICLE KEY MOUNT

(71) Applicants: JASON LEWIS, Kamas, UT (US); LEVI THOMPSON, Kamas, UT (US)

(72) Inventors: JASON LEWIS, Kamas, UT (US); LEVI THOMPSON, Kamas, UT (US)

(21) Appl. No.: 18/656,506

(22) Filed: May 6, 2024

Related U.S. Application Data
(60) Provisional application No. 63/500,401, filed on May 5, 2023.

(51) Int. Cl. A47G 29/10; F16M 13/02

(52) U.S. Cl. CPC A47G 29/10; F16M 13/02

(57) ABSTRACT

Various techniques are disclosed for a vehicle key mount. An apparatus includes a body that includes a mounting member at a first end of the body and an attachment member at a second end of the body. The mounting member is shaped and sized for securing a vehicle key that has a corresponding shape and size to the mounting member.

### CROSS-REFERENCES TO RELATED APPLICATIONS

This application claims the benefit of U.S. Provisional Patent Application No. 63/500,401 entitled “VEHICLE KEY MOUNT” and filed on May 5, 2023, for Jason Lewis, et al., which is incorporated herein by reference.

### FIELD

The subject matter disclosed herein relates to vehicle keys and more particularly relates to vehicle key mounts.

### BACKGROUND

Vehicles require keys for several operations, namely starting or turning on. Keys may come in a variety of shapes and sizes; however, some key types may be standard for certain classes of vehicles, e.g., off-road vehicles.

### SUMMARY

Various techniques are disclosed for a vehicle key mount. In one embodiment, an apparatus includes a body that includes a mounting member at a first end of the body and an attachment member at a second end of the body. In one embodiment, the mounting member is shaped and sized for securing a vehicle key that has a corresponding shape and size to the mounting member.

In one embodiment, an apparatus includes a body that includes a mounting member at a first end of the body and an attachment member at a second end of the body, the attachment member comprising an opening for connecting attachment means to the body. In one embodiment, the mounting member is substantially disk shaped for securing a vehicle key that has a corresponding disk shape to the mounting member.

In one embodiment, an apparatus includes a body that includes a mounting member at a first end of the body and an attachment member at a second end of the body, the attachment member comprising an opening for connecting attachment means to the body. In one embodiment, the mounting member has a substantially spherical shape for securing a vehicle key that has a corresponding spherical shape to the mounting member.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A illustrates an example of a vehicle key mount in accordance with the subject matter disclosed herein.

FIG. 1B illustrates an example of a vehicle key mount in accordance with the subject matter disclosed herein.

FIG. 2 illustrates an example of a vehicle key mount in accordance with the subject matter disclosed herein.

FIG. 3 illustrates an example of a vehicle key mount in accordance with the subject matter disclosed herein.

FIG. 4A illustrates an example of a vehicle key in accordance with the subject matter disclosed herein.

FIG. 4B illustrates an example of a vehicle key in accordance with the subject matter disclosed herein.

### DETAILED DESCRIPTION

In general, the subject matter disclosed herein relates to a mount for a vehicle key. The mount may be placed on a person, e.g., on a person's clothing, on a wall or other structure, or the like, for securing the vehicle key so that it is not misplaced, damaged, or the like.

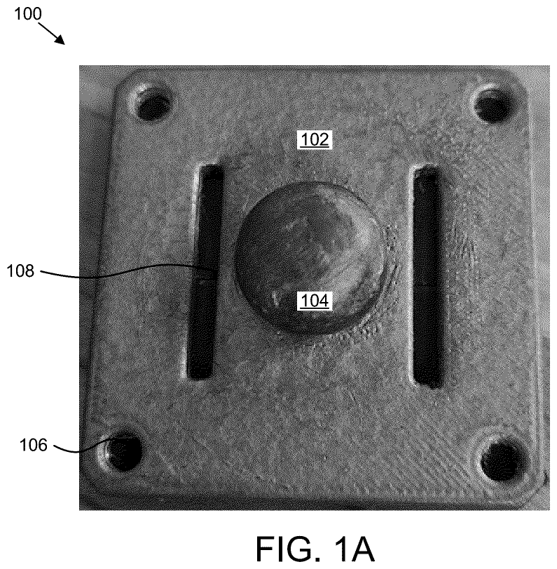

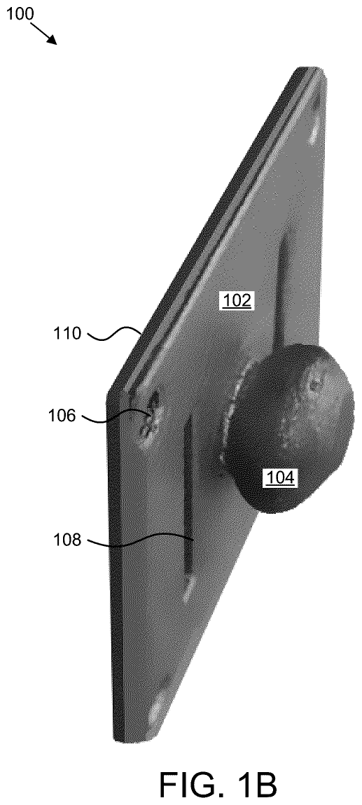

FIGS. 1A and 1B illustrate one embodiment of vehicle key mount 100 in accordance with the subject matter disclosed herein. In one embodiment, the vehicle key mount 100 includes a base member 102 and a mounting member 104 for mounting a vehicle key to the vehicle key mount 100. In one embodiment, the vehicle key mount 100 is made of plastic, metal, wood, or other rigid material.

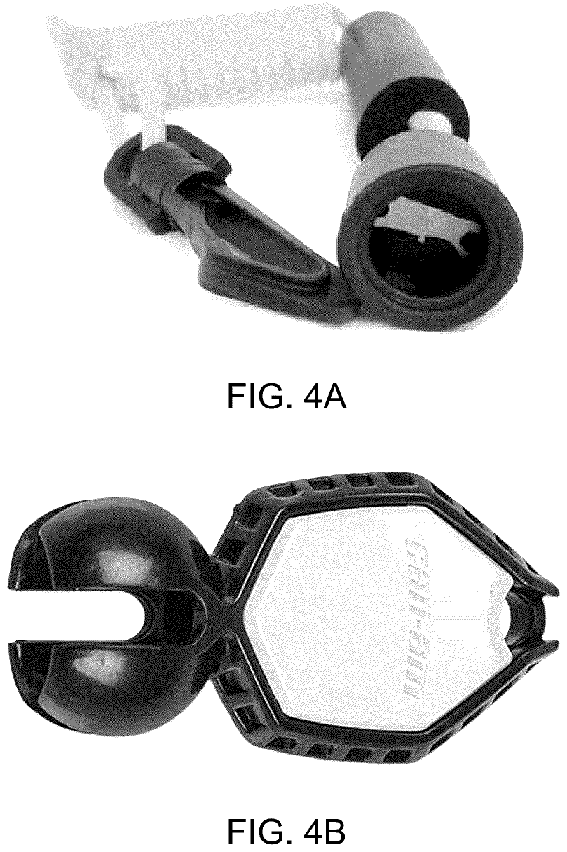

As shown in FIGS. 4A and 4B, the mounting member 104 may be configured to receive or mate with a vehicle key. The vehicle key may include a key for an offroad vehicle such as a four-wheeler, a utility task vehicle (“UTV”), a snowmobile, a jet ski, or the like. The vehicle key may be a digitally encoded security system (“DESS”) key that has a ball and socket design.

In such an embodiment, the mounting member 104 may have a ball design that matches the size and shape of the socket of the vehicle key. For instance, the mounting member 104 may have a spherical shape that tapers at the point where it is coupled or attached to the base member 102. Typically, as shown in FIG. 4A, the vehicle key includes a harness or cord that a user or rider can clip around the wrist or onto a piece of clothing so that if the rider falls off the vehicle, the key will come off as well, shutting the vehicle down.

Accordingly, when the key is not attached to the vehicle, the key may be dragged around and damaged or get dirty, may be lost, or the like. The vehicle key mount 100 shown in FIGS. 1A-1B provides a mounting location for the key when it is not attached to the vehicle.

The base member 102 of the vehicle key mount 100 may include a one or more holes 106 or openings for attaching the vehicle key mount 100 to a user (e.g., on a user's clothes using strings, cords, etc.), on a structure (e.g., using screws), and/or the like. In one embodiment, the vehicle key mount 100 may include one or more slots for attaching the vehicle key mount 100 to a user, e.g., via a belt or other harness. In one embodiment, the vehicle key mount 100 may include an attachment for clipping or otherwise attaching to a zipper, clip, loop, or other article on a user's clothing.

In certain embodiments, the vehicle key mount 100 may be configured to be sewn or otherwise directly integrated into clothing or other articles such as coats, life jackets, backpacks, belts, pants, swimming suits, and/or the like. Even though the base member 102 is shown with a square or rectangular shape in FIGS. 1A and 1B, the base member 102 may have any shape that provides means for securing the vehicle key mount 100 to a user or structure.

As shown in FIG. 1B, the base member 102 may include a coupling mechanism 110 on the backside of the base member 102. The coupling mechanism 110 may include a hook-and-loop fastening system, an adhesive, a magnet, and/or the like.

In one embodiment, the mounting member 104 is permanently fixed to the base member 102, e.g., the mounting member 104 and the base member 102 may be formed together. In one embodiment, the mounting member 104 may be selectively attached to the base member 102, e.g., may be screwed on, may be attached with a clip or friction fit, may be attached with a magnet, and/or the like, to accommodate mounting members 104 with different configurations, e.g., different sizes, shapes, or the like.

In one embodiment, the mounting member 104 includes a magnet that is configured to attract a magnet or metal in the vehicle key when the vehicle key is mounted to the mounting member 104, to further secure the vehicle key to the mounting member 104.

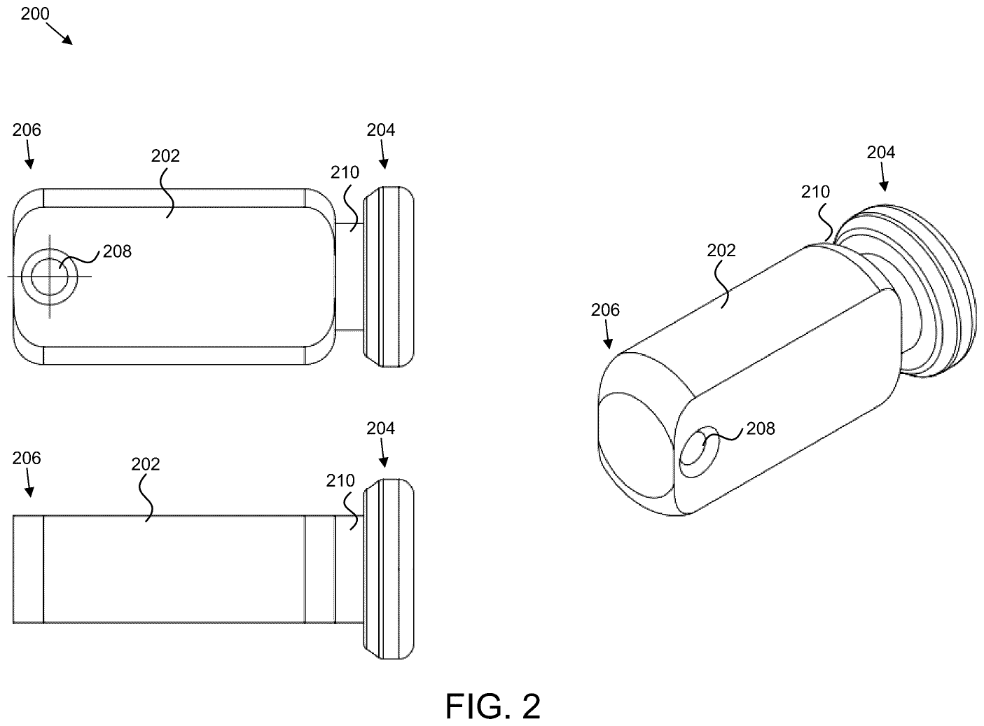

FIG. 2 depict another embodiment of a vehicle key mount 200. In one embodiment, the vehicle key mount 200 includes a body 202 that includes an end comprising a mounting member 204 and an end comprising an attachment member 206. In one embodiment, the vehicle key mount 200 is made of a substantially rigid, yet lightweight, material including aluminum, plastic, and/or the like. In some embodiments, the body includes a coating that protects the material and also provides a better grip, e.g., easier grip in wet conditions. The coating may include a rubber coating, a powder coating, a textured coating, and/or the like.

In one embodiment, the mounting member 204 is configured to mate with a vehicle key that has a corresponding shape and size. In such an embodiment, the mounting member 204 is tapered, chamfered, or the like to allow a corresponding vehicle key to mate with, grip, snap on, or the like the mounting member 204. For instance, the vehicle key mount 200 includes a neck point 210 that allows the vehicle key to completely encompass the mounting member 204 without conflicting with the body 202.

In one embodiment, the mounting member 204 may include various surface characteristics such as ridges, edges, grooves, angles, depths, widths, and/or the like that correspond to characteristics of the vehicle key and secure the vehicle key to the mounting member 204. For instance, in the embodiment depicted in FIG. 2, the mounting member 204 has a substantially flat end and is shaped similar to a disk to correspond to a vehicle key that has a socket with that is configured to correspond with a flat, disk-shaped mounting member 204.

However, the mounting member 204 may take various shapes depending on the corresponding vehicle key that the vehicle key mount 200 is designed for. In certain embodiments, the mounting member 204 is interchangeable with other mounting members 204 that may have different shapes, sizes, or other design configurations so that one vehicle key mount 200 can be used with different vehicle key types. In such an embodiment, the mounting member 204 may be attached to the body 202 using a screw fit, a snap fit, friction fit, or other securing means.

In certain embodiments, the mounting member 204 includes a magnet or magnetic material that corresponds to a magnet or magnetic material that is part of the vehicle key. In such an embodiment, the magnetic forces between the magnet or magnetic material in the mounting member 204 and in the vehicle key act as a secondary or additional means for securing the vehicle key to the vehicle key mount 200.

In one embodiment, the attachment member 206 may include an opening 208 or hole for attaching a key ring, clip, carabiner, or other attachment means that can be used to attach the vehicle key mount 200 to a person, e.g., on a zipper or clip of the person's clothing.

In one embodiment, the body 202 of the vehicle key mount 200 has a width that is greater than its height. The body 202 may include grooves, ridges, or other textured surfaces for assistance with gripping and using the vehicle key mount 220, especially in wet conditions such as snowmobiling or jet skiing.

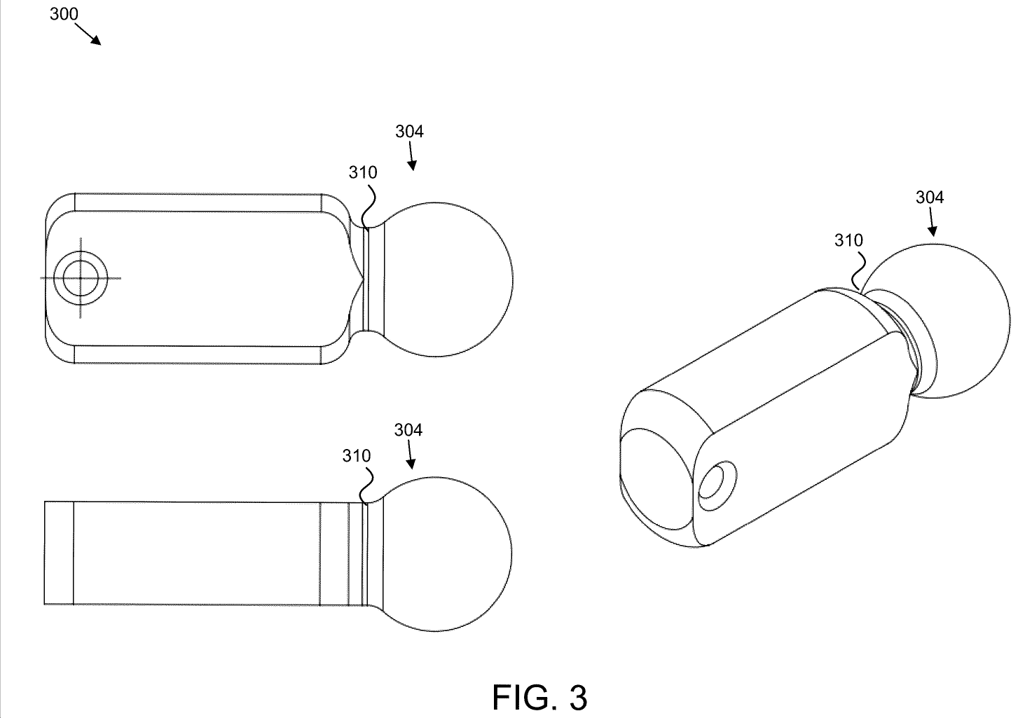

FIG. 3 depicts another embodiment of a vehicle key mount 300. In one embodiment, the vehicle key mount 300 depicted in FIG. 3 is substantially similar to the vehicle key mount 200 depicted in FIG. 2. However, in one embodiment, the vehicle key mount 300 includes a spherical mounting member 304, as opposed to the flat, disk-shaped mounting member depicted in FIG. 2.

In this embodiment, the vehicle key mount 300 is shaped and designed to correspond to a vehicle key that includes a similar configuration, e.g., a socket that corresponds to the round mounting member 304. Further, the neck point 310 is shaped and designed to allow the socket of the vehicle key to fully encompass the mounting member 304 and secure the vehicle key to the vehicle key mount 300.

FIG. 4A depicts one embodiment of a vehicle key that corresponds to a vehicle key mount 200 that has a flat, disk-shaped mounting member 204.

FIG. 4B depicts one embodiment of a vehicle key that corresponds to a vehicle key mount 300 that has a round, spherically-shaped mounting member 304.

The vehicle keys depicted in FIGS. 4A and 4B may be keys for off-road vehicles, such as snowmobiles, jet skis, dirt bikes, or the like. A rider may connect the key to their person, e.g., via a clip on a rider's jacket, so that if the rider gets off or falls off the vehicle, the key will also be removed from the vehicle so that the vehicle stops running. When the key is not attached to the vehicle, a user may attach the key to the vehicle key mount disclosed herein, to prevent damage, loss, or the like.

In one embodiment, an apparatus includes a body that includes a mounting member at a first end of the body and an attachment member at a second end of the body. In one embodiment, the mounting member is shaped and sized for securing a vehicle key that has a corresponding shape and size to the mounting member.

In one embodiment, the mounting member is substantially disk shaped. In one embodiment, the mounting member has a substantially spherical shape.

In one embodiment, the apparatus includes a neck point where the mounting member is coupled to the body, the neck point being substantially narrower than the mounting member and the body.

In one embodiment, the mounting member comprises characteristics on its surface corresponding to characteristics on a surface of the vehicle key. In one embodiment, the characteristics comprise one or more angles, edges, or grooves that correspond to one or more angles, edges, or grooves on the vehicle key.

In one embodiment, the mounting member comprises magnetic material. In one embodiment, the body further comprises a coating. In one embodiment, the body further comprises a textured surface. In one embodiment, the body comprises one or more ridges or grooves. In one embodiment, the attachment member comprises an opening for connecting attachment means to the body.

In one embodiment, an apparatus includes a body that includes a mounting member at a first end of the body and an attachment member at a second end of the body, the attachment member comprising an opening for connecting attachment means to the body. In one embodiment, the mounting member is substantially disk shaped for securing a vehicle key that has a corresponding disk shape to the mounting member.

In one embodiment, the apparatus includes a neck point where the mounting member is coupled to the body, the neck point being substantially narrower than the mounting member and the body.

In one embodiment, the mounting member comprises characteristics on its surface corresponding to characteristics on a surface of the vehicle key. In one embodiment, the characteristics comprise one or more angles, edges, or grooves that correspond to one or more angles, edges, or grooves on the vehicle key.

In one embodiment, the mounting member comprises magnetic material. In one embodiment, the body further comprises a coating. In one embodiment, the body further comprises a textured surface. In one embodiment, the body comprises one or more ridges or grooves. In one embodiment, the attachment member comprises an opening for connecting attachment means to the body.

In one embodiment, an apparatus includes a body that includes a mounting member at a first end of the body and an attachment member at a second end of the body, the attachment member comprising an opening for connecting attachment means to the body. In one embodiment, the mounting member has a substantially spherical shape for securing a vehicle key that has a corresponding spherical shape to the mounting member.

In one embodiment, the apparatus includes a neck point where the mounting member is coupled to the body, the neck point being substantially narrower than the mounting member and the body.

In one embodiment, the mounting member comprises characteristics on its surface corresponding to characteristics on a surface of the vehicle key. In one embodiment, the characteristics comprise one or more angles, edges, or grooves that correspond to one or more angles, edges, or grooves on the vehicle key.

In one embodiment, the mounting member comprises magnetic material. In one embodiment, the body further comprises a coating. In one embodiment, the body further comprises a textured surface. In one embodiment, the body comprises one or more ridges or grooves. In one embodiment, the attachment member comprises an opening for connecting attachment means to the body.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus, comprising:
a body comprising:
a mounting member at a first end of the body; and
an attachment member at a second end of the body,
wherein the mounting member is shaped and sized for securing a vehicle key that has a corresponding shape and size to the mounting member.

2. The apparatus of claim 1, wherein the mounting member is substantially disk shaped.

3. The apparatus of claim 1, wherein the mounting member has a substantially spherical shape.

4. The apparatus of claim 1, further comprising a neck point where the mounting member is coupled to the body, the neck point being substantially narrower than the mounting member and the body.

5. The apparatus of claim 1, wherein the mounting member comprises characteristics on its surface corresponding to characteristics on a surface of the vehicle key.

6. The apparatus of claim 5, wherein the characteristics comprise one or more angles, edges, or grooves that correspond to one or more angles, edges, or grooves on the vehicle key.

7. The apparatus of claim 1, wherein the mounting member comprises magnetic material.

8. The apparatus of claim 1, wherein the body further comprises a coating.

9. The apparatus of claim 1, wherein the body further comprises a textured surface.

10. The apparatus of claim 1, wherein the body comprises one or more ridges or grooves.

11. The apparatus of claim 1, wherein the attachment member comprises an opening for connecting attachment means to the body.

12. An apparatus, comprising:
a body comprising:
a mounting member at a first end of the body; and
an attachment member at a second end of the body, the attachment member comprising an opening for connecting attachment means to the body,
wherein the mounting member is substantially disk shaped for securing a vehicle key that has a corresponding disk shape to the mounting member.

13. The apparatus of claim 12, further comprising a neck point where the mounting member is coupled to the body, the neck point being substantially narrower than the mounting member and the body.

14. The apparatus of claim 12, wherein the mounting member comprises characteristics on its surface corresponding to characteristics on a surface of the vehicle key.

15. The apparatus of claim 14, wherein the characteristics comprise one or more angles, edges, or grooves that correspond to one or more angles, edges, or grooves on the vehicle key.

16. The apparatus of claim 12, wherein the mounting member comprises magnetic material.

17. An apparatus, comprising:
a body comprising:
a mounting member at a first end of the body; and
an attachment member at a second end of the body, the attachment member comprising an opening for connecting attachment means to the body,
wherein the mounting member has a substantially spherical shape for securing a vehicle key that has a corresponding spherical shape to the mounting member.

18. The apparatus of claim 17, further comprising a neck point where the mounting member is coupled to the body, the neck point being substantially narrower than the mounting member and the body.

19. The apparatus of claim 17, wherein the mounting member comprises characteristics on its surface corresponding to characteristics on a surface of the vehicle key.

20. The apparatus of claim 19, wherein the characteristics comprise one or more angles, edges, or grooves that correspond to one or more angles, edges, or grooves on the vehicle key.
